(19) United States
(12) Patent Application Publication
(10) Pub. No.: US 2025/0210745 A1
(43) Pub. Date: Jun. 26, 2025

(54) HEAT-TRANSFER SYSTEM FOR A BATTERY

(71) Applicant: Volvo Car Corporation, Göteborg (SE)

(72) Inventor: Rui CÉSAR, Göteborg (SE)

(21) Appl. No.: 18/971,393

(22) Filed: Dec. 6, 2024

(30) Foreign Application Priority Data
Dec. 21, 2023 (EP) 23218938.1

(51) Int. Cl. H01M 10/63; B60R 16/033; H01M 10/613; H01M 10/625; H01M 10/653; H01M 10/6554; H01M 50/204; H01M 50/249

(52) U.S. Cl. CPC H01M 10/63; H01M 10/613; H01M 10/625; H01M 10/653; H01M 10/6554; H01M 50/204; H01M 50/249; B60R 16/033; H01M 2220/20

(57) ABSTRACT

The disclosure relates to heat-transfer for a battery. The battery can comprise at least one battery unit. The heat-transfer system can comprise a first heat-conducting element for thermal connection to the at least one battery unit, a second heat-conducting element for thermal connection to a battery external environment, and an actuator configured to alter a position of the first heat-conducting element between a first position for connecting the first heat-conducting element to at least one of the second heat-conducting element and the at least one battery unit and a second position for disconnecting the first heat-conducting element from at least one of the second heat-conducting element and the at least one battery unit. The first heat-conducting element can be configured to receive heat from the at least one battery unit and transfer the heat to the second heat-conducting element in the first position.

### CROSS REFERENCE TO RELATED APPLICATIONS

This application claims the benefit of and priority to pending EP patent application serial number 23218938.1, filed Dec. 21, 2023, and entitled “A HEAT-TRANSFER SYSTEM FOR A BATTERY,” the entirety of which is hereby incorporated by reference herein.

### TECHNICAL FIELD

The present disclosure relates to batteries and, more particularly, to heat-transfer for a battery.

### BACKGROUND

In battery systems, such as batteries for electric vehicles and other applications, effective temperature control is critical for battery performance and lifespan.

However, the structure of the battery of existing cooling systems or heat-transfer systems inevitably promotes heat exchange with the environment through physical connections between the battery cells and a battery external environment, which is exposed to environmental temperature conditions. This can lead to inefficient cooling of the battery cells and thus to impaired performance and lifespan of the battery.

### SUMMARY

The above problem is at least partially solved or alleviated by the subject matter of the independent claims of the present disclosure, wherein further examples are incorporated in the dependent claims.

The present disclosure relates to a heat-transfer system for a battery, a battery, a method for controlling a heat-transfer in a battery, and a computer program product.

According to a first aspect, there is provided a heat-transfer system for a battery having at least one battery unit, the heat-transfer system comprising a first heat-conducting element for thermal connection to the at least one battery unit, the heat-transfer system further comprising a second heat-conducting element for thermal connection to a battery external ambient environment, and the heat-transfer system comprising an actuator, the actuator being configured to alter the position of at least a portion of the first heat-conducting element between a first position for connecting the first heat-conducting element to at least one of the second heat-conducting element and the at least one battery unit and a second position for disconnecting the first heat-conducting element from at least one of the second heat-conducting element and the at least one battery unit, and the first heat-conducting element being configured to receive heat from the battery unit and transfer it to the second heat-conducting element in the first position.

Accordingly, the heat-transfer system enables variable control of heat-transfer within a battery having at least one battery unit. A battery unit can be a battery cell, several battery cells which can be connected with each other, a battery module with several battery cells, wherein several battery units can form the battery. Heat-transfer can mean the transfer of heat between two components, for example between the first heat-conducting element and the at least one battery unit and/or the transfer of heat between the first heat-conducting element and the second heat-conducting element. The first heat-conducting element is intended for, in particular configured for, thermal connection to the at least one battery unit. Thermal connection can describe a physical link or interface that allows efficient transfer of heat from one component to another. This means heat generated by the at least one battery can be absorbed and transferred via the first heat-conducting element to the second heat-conducting element. The first heat-conducting element can further facilitate the transfer of heat from the at least one battery unit to a battery external environment. The first heat-conducting element can be made of copper, aluminum, graphite/graphene, ceramics, or any other material or combination of materials. It is noted that the choice of material can depend on the dimension and/or the design of the first heat-conducting element and the second heat-conducting element. The choice of material or combination of materials can be chosen based on their coefficient of heat-transfer and/or other measures of heat-transfer. The second heat-conducting element is intended, in particular configured, for thermal connection to the battery external environment. Battery external environment can refer to an area outside of the at least one battery unit. The second heat-conducting element can for example form a part of a vehicle chassis to facilitate efficient heat-transfer from the at least one battery unit to the battery external environment. The second heat-conducting element can be configured to receive heat from the first heat-conducting element. The heat-transfer system can further comprise an actuator configured to alter the position of the first heat-conducting element between a first and a second position. In the first position the first heat-conducting element can be connected to at least one of the second heat-conducting element and the at least one battery unit. In the first position the first heat-conducting element can be configured to receive heat from the at least one battery unit and transfer it to the second heat-conducting element. In the second position the first heat-conducting element can be disconnected from the second heat-conducting element and/or the at least one battery unit. In this way, the heat-transfer between the at least one battery unit and the second heat-conducting element can be interrupted. Thus, the heat-transfer system can provide both prevention of degradation of a battery during high temperatures in the first position and a thermal insulation of a battery from the external ambient environment in the second position to maintain an optimal working temperature for example. Additionally, the heat-transfer system can be connectable with a pre-existing cooling system of the vehicle, such as a thermal control system of the vehicle. The connection of the heat-transfer system can be achieved by using at least one of a valve and/or pump. Thus, the heat-transfer system can work together with the thermal control system of the vehicle or independently of it.

According to an example, the first heat-conducting element can comprise a first portion for connection to the at least one battery unit in the first position and a second portion for connection to the second heat-conducting element in the first position, the second portion can be arranged at an end of the first portion. The first portion can be designed to maximize a contact surface area with the at least one battery unit. For example, the first portion can be arranged to be in direct contact with the at least one battery unit to facilitate the heat-transfer from the at least one battery unit to the first portion of the first heat-conducting element. Thus, most or substantially the entire surface of the first portion facing the at least one battery unit can be configured to come into contact with the at least one battery unit. Any other arrangement that enables heat-transfer is also conceivable. The second portion of the first heat-conducting element can be designed to maximize a contact surface area with the second heat-conducting element. Thus, most or substantially the entire surface of the second portion facing the second heat-conducting element can be configured to come into contact with the second heat-conducting element. The first portion and the second portion can be arranged in a modular way. This means that the first portion and the second portion can be separate parts which can be in contact with each other. For example, the first portion and the second portion can be rectangular in shape, where the shapes can be connected with each other. This can enhance its versatility and adaptability in managing heat-transfer within the system. However, the first portion and the second portion can also be arranged in one piece. It is also conceivable that the first portion and the second portion can be divided in several sub portions.

According to an example, the second portion of the first heat-conducting element can extend transverse to the first portion of the first heat-conducting element. Transverse can mean at substantially a right angle or substantially perpendicular to the first portion. A right angle can mean that the second portion can extend at an angle of 90 degrees relative to the first portion. Other configurations are possible, for example the second portion might be curved or bent, allowing for more flexibility in the connection or enhancing the heat-transfer in certain directions. Instead of being strictly transverse, the second portion can intersect with the first portion. This means that the two portions of the heat-conducting element (the first portion and the second portion) are not necessarily arranged at a right angle or perpendicular to each other. Instead of extending at a clear 90-degree angle, the second portion might cross or overlap with the first portion at some point. This can serve specific design goals, such as providing additional structural support. The first heat-conducting element can be designed in a modular way, allowing for interchangeable parts with different orientations. This can provide flexibility in adapting the system to diverse applications. For example, the modular design can allow for choosing the material of the different portions of the first heat-conducting element for transferring heat in the first position and insulating the at least one battery unit in the second position.

According to an example, the heat-transfer system can comprise a control system for receiving a signal indicative of the temperature of the at least one battery unit. The control system can further be configured to control the actuator to alter the position of at least the first portion and/or the second portion of the first heat-conducting element based on the signal. To receive the signal, a measurement of the temperature can be performed. To measure the temperature of the at least one battery unit, one or more sensors can be integrated into or arranged at or near the at least one battery unit. This sensor or these sensors can be thermocouples, thermistors, infrared sensors, or any other type capable of providing accurate temperature measurements. The signal indicative of the temperature in the heat-transfer system can be at least one of a voltage signal, digital signal, wireless transmission signal, or similar based on the type of sensor or technology used. For example, the control system can receive the signal indicative of the temperature of the at least one battery unit and processes it to determine an appropriate action. The control system can include at least one or multiple algorithms, thresholds, and/or logics to make decisions based on the temperature information. Based on the processed temperature information, the control system can decide whether an adjustment of the heat-transfer shall be provided. If the control system determines that an adjustment is favorable or needed, it can send one or more signals or commands to the actuator. The actuator can respond by altering the position of the first portion and/or the second portion of the first heat-conducting element, bringing it for example in contact with the second heat-conducting element to transfer heat from the at least one battery unit to the battery external environment. The control system can optimize the heat-transfer based on real-time temperature measurements, preventing overheating or excessive cooling of the at least one battery unit.

According to an example, the heat-transfer system can be configured to control the actuator to alter the position of at least the portion of the first heat-conducting element based on a comparison of the signal to a threshold. For example, if the temperature signal exceeds a predefined threshold, indicating the at least one battery unit is overheating, the control system can instruct the actuator to enhance heat-transfer by altering the position of the first heat-conducting element for increased heat-transfer from the at least one battery unit. Another example can be if the temperature signal falls below a predefined threshold, suggesting the battery unit is too cold. In this case, the control system might instruct the actuator to alter the position of the first heat-conducting element to reduce the heat-transfer from the at least one battery unit for increased insulating efficiency. Thus, the first heat-conducting element can have an insulating property in the second position. Depending on whether the first heat-conducting element has an insulating or cooling effect, the first heat-conducting element can also be arranged in any intermediate position between the first and the second position. The adaptability of the first heat-conducting element to various positions allows the heat-transfer system to dynamically respond to different thermal conditions, optimizing both insulation and cooling based on the current conditions of the at least one battery unit.

According to an example, the heat-transfer system can be configured to control the actuator for altering the position of at least the first portion and/or the second portion of the first heat-conducting element based on the signal indicative of the temperature of the at least one battery unit and at least one further signal indicative of the temperature of a vehicle comprising the heat-transfer system and/or a temperature of a battery external environment. The control system can process the information from at least one of an additional signal related to the temperature of a vehicle comprising the heat-transfer system and/or the temperature signals of the battery external environment to make decisions about the position of the first heat-conducting element. One or more additional sensors can be arranged at or within the vehicle for this purpose or pre-existing sensors within the vehicle can be used for this. Also, signals indicative of performance requirements such as vehicle speed can contribute to the processing step of the control system. This can allow for proactive measures to prevent overheating during, e.g., high-speed driving.

According to an example, the actuator can be configured to alter the position of at least the first portion and/or the second portion of the first heat-conducting element by at least one of a linear movement and/or a rotating movement of at least the first portion and/or the second portion of the first heat-conducting element. If the actuator is configured for linear movement, it can extend or retract a portion of the first heat-conducting element along a substantially straight line, facilitating the thermal connection with the second heat-conducting element. If the actuator is configured for rotating movement, it can pivot or rotate a portion of the first heat-conducting element, achieving a similar effect by changing its orientation for improved heat-transfer. The actuator can also integrate both linear and rotational movements, or run in sequential linear and rotational movements, for example.

According to an example, the heat-transfer system can further comprise a spacer for spacing apart the second heat-conducting element from the at least one battery unit. The spacer can be arranged between the at least one battery unit and the second heat-conducting element. The spacer can prevent a direct heat-transfer of the at least one battery unit to the second heat-conducting element. The design of the spacer can be variable in width, thickness, number, or similar allowing for adjustments in the distance between the second heat-conducting element and the at least one battery unit. In another example, a cooling plate can be arranged between the spacer and the at least one battery unit. This way the at least one battery unit is further thermally insulated from the second heat-conducting element.

According to an example, the spacer can have a lower thermal conductivity than the second heat-conducting element. Accordingly, the spacer can be less efficient at transferring heat compared to the second heat-conducting element. This can enhance the thermal insulation properties of the spacer, insulating the at least one battery unit from the second heat-conducting element, allowing for controlled heat-transfer within the system. Depending on the material, the spacer can also absorb shocks or vibrations, that would otherwise damage the at least one battery unit or the cooling plate, respectively. The choice of material or combination of materials can be chosen based on their thermal and mechanical properties.

According to an example, the heat-transfer system can further comprise a cooling plate for thermal connection to the at least one battery unit, and a heat sink. The cooling plate can be a component designed to establish a thermal connection with the at least one battery unit. A thermal connection to the battery unit can allow for efficient heat-transfer for example by absorbing excess heat from the at least one battery unit. The heat sink can be integrated into or arranged at the second heat-conducting element and can provide an additional mechanism for transferring heat. It can absorb heat from various components in the system and release it to the battery external environment, enhancing overall cooling of the at least one battery unit.

According to an example, the heat-transfer system can further comprise a cooling circuit for connecting the cooling plate to the heat sink. For example, if a temperature of the at least one battery unit reaches a certain threshold, e.g., by applying a heavy load on the battery, which can be the case for uphill driving or warm weather conditions where further thermal loads due to usage of air conditioning stresses the thermal system of the vehicle, which increases the demand on the at least one battery unit, an additional heat-transfer mechanism can be activated. In this example, the cooling circuit can be a pathway that facilitates the flow of a cooling medium (such as a liquid or gas), e.g., comprising or being water, between the cooling plate and the heat sink. This can be achieved by integrating at least one of a valve and/or pump thus creating a loop circuit between the heat sink and the cooling plate. Thus, in response to high temperatures of the at least one battery unit or where a high battery performance is expected due to high vehicle speed for example, the control system can activate the valves and/or the pumps to connect the cooling circuit to absorb excess heat from the battery unit.

According to an example, the second heat-conducting element can be at least a portion of a battery housing for the at least one battery unit. The part of the battery housing connectable to the first heat-conducting element can be in connection to a battery external environment. This can ensure effective heat-transfer between the at least one battery unit and the battery external environment or environmental conditions. In another example, the at least one battery unit and the cooling plate can be assembled on the opposite side of the battery housing portion, which can be in connection with the battery external environment, keeping an open air section between the at least one battery unit and the battery housing. This promotes the insulating properties of the heat-transfer system in the second position and the heat-transfer in the first position. The second heat-conducting element, or at least the part that can be in connection with the battery external environment, can be made of materials with a high thermal conductivity for effectively transporting the heat transferred by the first heat-conducting element.

According to a second aspect, there is provided a battery having at least one battery unit, the battery comprising the heat-transfer system.

According to a third aspect, there is provided a method for controlling a heat-transfer in a battery having at least one battery unit, the method comprising:
obtaining a signal indicative of a temperature of the at least one battery unit;
comparing the signal to a threshold;
obtaining a control signal for an actuator of the battery based on the comparison, the control signal being executable by the actuator for altering a position of at least a portion of a first heat-conducting element of the battery between a first position for connecting the first heat-conducting element to at least one of the second heat-conducting element of the battery and the at least one battery unit and a second position for disconnecting the first heat-conducting element from at least one of the second heat-conducting element and the at least one battery unit.

The method can be at least partly computer-implemented, wherein one, multiple or all the steps of the method can be carried out by a computer. The method can be implemented in software or in hardware, or in software and hardware. Further, the method can be carried out by computer program instructions running on means that provide data processing functions. The data processing means can be a suitable computing means, such as an electronic control module, a device, etc., which can also be a distributed computer system. The data processing means or the computer, respectively, can comprise one or more of a processor, a memory, a data interface, or the like.

According to a fourth aspect, there is provided a computer program product comprising instructions which, when the program is executed by a computer, cause the computer to carry out the method of the third aspect. The computer program product can be a computer program as such or a product, e.g., a computer readable medium, having stored the computer program thereon.

It is noted that the above examples can be combined with each other irrespective of the aspect involved. In particular, aspects of the disclosure described herein can be applied to the heat-transfer system for a battery, the battery, the method for controlling a heat-transfer in a battery and the computer program product.

These and other aspects of the present disclosure will become apparent from and elucidated with reference to the examples described hereinafter.

### BRIEF DESCRIPTION OF DRAWINGS

Examples of the disclosure will be described in the following with reference to the following schematic drawings.

FIGS. 1A-1B show an example of a heat-transfer system in a first position (FIG. 1A) and a second position (FIG. 1B).

FIG. 2 shows an alternative example of a heat-transfer system.

FIGS. 3A-3B show variations in the heat-transfer system of any one of FIGS. 1A, 1B, and 2.

FIG. 4 shows a schematic illustration of a method for controlling a heat-transfer in a battery.

FIG. 5 shows a vehicle comprising a heat-transfer system according to this disclosure.

### DETAILED DESCRIPTION

The Figures are merely schematic representations and serve only to illustrate examples of the disclosure. Identical or equivalent elements are in principle provided with the same reference signs.

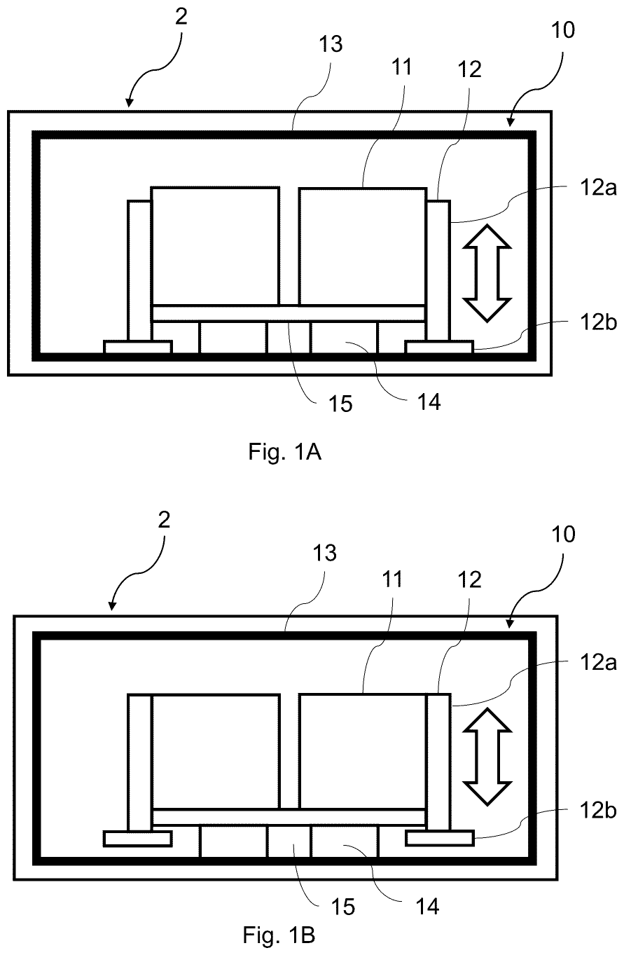

FIGS. 1A and 1B show a battery 2 comprising a heat-transfer system 10, the heat-transfer system 10 comprising two battery units 11, one first heat-conducting element 12 arranged at each battery unit 11, and a second heat-conducting element 13. This example shows a battery 2 comprising two battery units 11, but also one or several battery units 11 are conceivable. In this example one first heat-conducting element 12 is arranged at each battery unit 11, but constellations are also possible in which only one first heat-conducting element 12 is provided at one side of the battery unit 11. However, one first heat-conducting element 12 can also be arranged at each battery unit 11 or only a partial number of them. In the example shown, a first heat-conducting element 12 is arranged at an outside facing side of each of the two battery units 11 to transfer the heat. However, configurations are also conceivable in which one or each of the first heat-conducting elements 12 is arranged at an inside facing side of the battery units 11. In the example shown, this would be the space between the two battery units 11. But also constellations in which the one or each of the first heat-conducting elements 12 is arranged at an above or underneath facing side of the battery units 11. The first heat-conducting element 12 further comprises a first portion 12a and a second portion 12b. In this example, the first portion 12a and the second portion 12b are of rectangular shape and the second portion 12b of the first heat-conducting element 12 extends transverse to the first portion 12a. However, other configurations are also possible in which the first portion 12a and the second portion 12b are curved or comprise other forms, distinct to each other. The first heat-conducting element 12 can also be in one piece. The first portion 12a of the first heat-conducting element is in thermal connection with the battery unit 11 and is configured to receive heat from the battery unit 11. The position of the first heat-conducting element 12 can be altered in a way, that in a first position (FIG. 1A) the second portion 12b of the first heat-conducting element 12 is connected to the second heat-conducting element 13. This way, the received heat from the battery unit 11 can be transferred from the first heat-conducting element 12 to the second heat-conducting element 13. In the second position (FIG. 1B) the second portion 12b of the heat-conducting element 12 is disconnected from the second heat-conducting element 13 and the heat-transfer from the first heat-conducting element 12 to the second heat-conducting element 13 is interrupted. The alteration between the first position and the second position can be facilitated by an actuator 18 (indicated by the arrow). In this example the alteration of the position between the first and the second position occurs in a linear way. The alteration between the first position and the second position can also be in a rotating manner or in a linear and rotating manner, respectively. In this example the position of both heat-conducting elements 12 are altered parallel in time. Configurations in which both or several first heat-conducting elements 12 are controlled and thus altered in position independently of each other are also possible. Additionally, two spacers 14 and a cooling plate 15 are arranged between the second heat-conducting element 13 and the battery unit 11. The spacers 14 prevent a direct heat-transfer of the battery unit 11 to the second heat-conducting element 13. For this purpose, the spacers 14 can have a lower thermal conductivity than the second heat-conducting element 13. Two rectangular spacers 14 are shown here exemplary. But there can be just one spacer 14 or several spacers 14 arranged between the second heat-conducting element 13 and the cooling plate 15. Also, the form of the spacers 14 can vary and can be in cylindrical shape or any other shape suitable. Also, examples in which the spacer 14 is directly arranged between the battery unit 11 and the second heat-conducting element 13 are conceivable. The cooling plate 15 is arranged between the battery unit 11 and the second heat-conducting element 13 and establishes a thermal connection with the battery unit 11 and allows for additional heat-transfer of, for example, excess heat. The second heat-conducting element 13 in this example represents a battery housing 13. The part of the battery housing 13 connectable to the first heat-conducting element 12 can be in connection to a battery external environment to ensure effective heat-transfer between the one battery unit 11 and the environment.

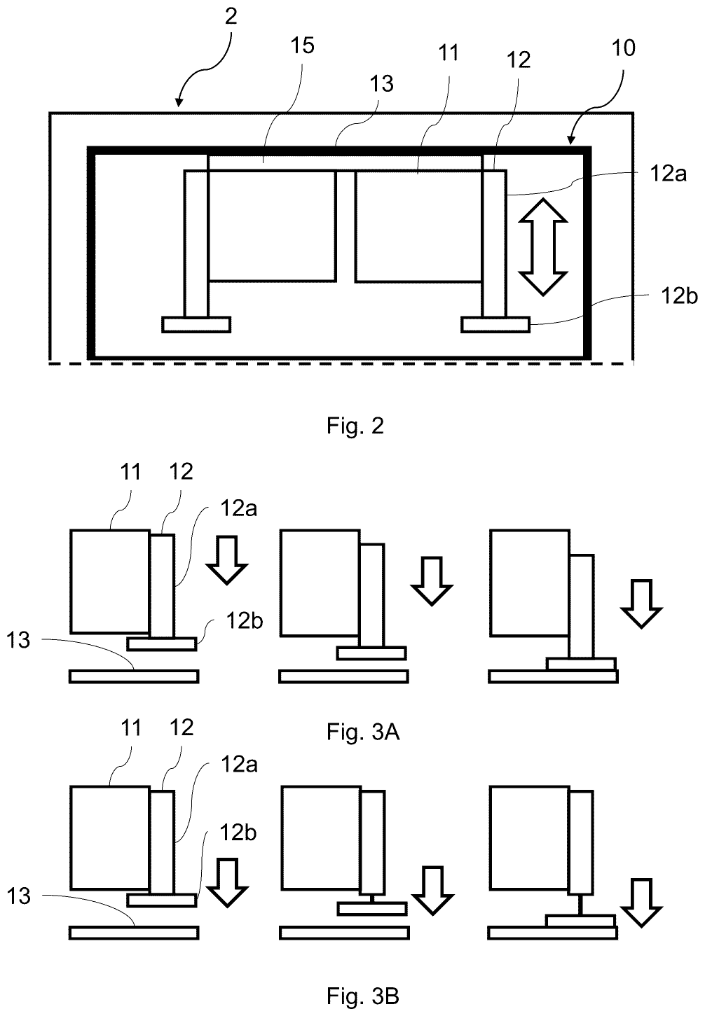

FIG. 2 shows an example of a heat-transfer system 10, which differs from the one of FIGS. 1A, 1B in that the battery unit 11 and the cooling plate 15 are assembled on the opposite side of the part of the second heat-conducting element 13 or the battery housing 13 which is in contact with the battery external environment (indicated by the dotted lines). The battery external environment can refer to an area outside of the battery unit 11 or the battery 2. The battery housing 13 can for example form a part of a vehicle chassis to facilitate efficient heat-transfer from the battery unit 11 to the battery external environment. This way, a spatial distance between the part of the battery housing which is in contact with the battery external environment and the battery unit 11 is achieved. Or in other words, an open air section between the at least one battery unit 11 and the battery housing 13 is maintained. This promotes, for example, the insulating properties of the heat-transfer system 10 in the second position as the battery unit 11 is not in contact with the battery housing 13 portion which is in contact with the battery external environment. The heat-transfer system 10 or the first heat-conducting element 12 thereby becomes the only part of the heat-transfer system 10 responsible for transferring heat from the at least one battery unit 11 to the battery housing 13 being in contact with the battery external environment. Assembling the at least one battery unit 11 and the heat-transfer system 10 this way, a spacer 14 as shown in FIGS. 1A and 1B may not be required.

FIGS. 3A and 3B show exemplary two variations in the heat-transfer system of any one of FIGS. 1A, 1B, and 2. FIG. 3A shows the example of heat-transfer mentioned above where the position of the first heat-conducting element 12 is moved from a first position to a second position, indicated by the arrows. FIG. 3B shows an embodiment in which not the entire first heat-conducting element 12 is moved, but only a portion, in this example the second portion 12b, of the first heat-conducting element 12. In the second position, the second portion 12b is in thermal connection with the second heat-conducting element 13, while the position of the first portion 12a of the heat-conducting element 12 remains unchanged. This way, the first portion 12a can have better isolating properties compared to the embodiment of FIG. 3A. In this example, the second portion 12b of the first heat-conducting element 12 extends transverse to the first portion 12a of the first heat-conducting element 12 and the movement of the first portion 12a and/or the second portion 12b of the first heat-conducting element 12 occurs in a linear manner. Other configurations of heat-transfer are possible depending on the type of actuator 18 (indicated by the arrows) being used. The actuator 18 can move the position of the first portion 12a and/or the second portion 12b of the first heat-conducting element 12 in a linear and/or rotating movement.

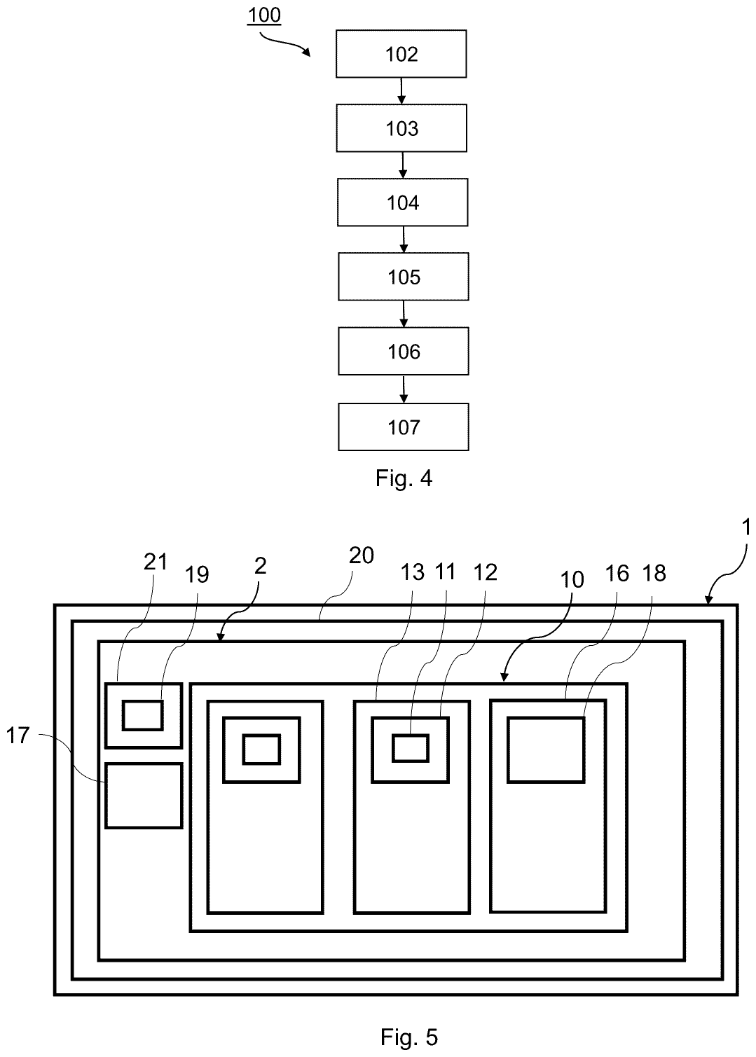

In FIG. 4, steps for carrying out the method 100 for transferring heat from an at least one battery unit 11 to a battery external environment are shown. The method 100 can be carried out by a data processing apparatus 21, which comprises a computer program product 19. In a first step 102 of method 100, a signal indicative of a temperature of at least one battery unit 11 can be obtained by the data processing apparatus 21. For example, the signal may have been generated by a sensor 17, especially a temperature sensor 17. In a next step 103 of method 100, the signal indicative of a temperature of the at least one battery unit 11 is obtained by a control system 16. The control system 16 comprises an actuator 18 for altering a position of a first heat-conducting element 12. This signal can be provided in real-time, thus giving real-time information about the thermal state of the at least one battery unit 11 during its operation. In step 104 of method 100 the obtained signal is compared to a predetermined threshold. This threshold serves as a reference point, determining whether the temperature of the at least one battery unit 11 is within an acceptable range or if it has exceeded a predefined threshold. Based on the comparison of the temperature with the threshold, a control signal is generated by the data processing apparatus 21 in a further step 105 of method 100. This control signal controls the actuator 18, which in turn can in a further step 106 alter the position of the first heat-conducting element 12 according to the determined temperature of the at least one battery unit 11. The position of the actuator 18 can be altered between a first position for connecting the first heat-conducting element 12 to at least one of the second heat-conducting element 13 of the at least one battery unit 11 and a second position for disconnecting the first heat-conducting element 12 from at least one of the second heat-conducting element 13 and the at least one battery unit 11. The control system 16 can continuously monitor the temperature of the at least one battery unit 11 with the sensor 17 and adjust the position of the first heat-conducting element 12 accordingly. This closed-loop system actively responds to temperature changes, optimizing heat-transfer, and maintaining ideal operating conditions for the at least one battery unit 11. In an additional step 106, if a temperature of the at least one battery unit 11 reaches a certain threshold, an additional heat-transfer mechanism comprising a cooling plate 15 and a heat sink can be activated. This can be achieved by activating at least one of a valve and/or pump, thus creating a loop circuit between the heat sink and the cooling plate 15. In a further alternative step 107 the heat-transfer system 10 described can be combined with a pre-existing cooling system 20 of the vehicle 1.

FIG. 5 shows a vehicle 1 comprising a heat-transfer system 10 for a battery 2 and a battery 2. The heat-transfer system 10 comprises at least one battery unit 11 and a control system 16 comprising an actuator 18. The control system 16 generates a control signal if a predefined temperature threshold is exceeded. The actuator 18 receives the control signal and is controlled accordingly. The actuator is configured to alternate a position of a first heat-conducting element 12 between a first position, for connecting the first heat-conducting element 12 to the second heat-conducting element 13, and a second position for disconnecting the first heat-conducting element 12 from the second heat-conducting element 13. Heat produced by the at least one battery unit 11 is absorbed by the first heat-conducting element 12 and is transferred to the second heat-conducting element 13 in the first position. Whereas in the second position, this heat-transfer from the first heat-conducting element 12 to the second heat-conducting element 12 is interrupted. Additionally, the heat-transfer system 10 can be combined with a pre-existing cooling system 20 of the vehicle 1 by activating at least one of a pump and/or valve, for example. At least some or all of the previously mentioned steps 102 to 107 can be carried out by a data processing apparatus 21, for example. The battery 2 further comprises one or more sensors 17, preferably temperature sensors 17. The sensor 17 monitors the temperature of the at least one battery unit 11. As shown herein exemplary, the control system 16 can be part of a heat-transfer system 10 including the actuator 18 and the respective components for transferring heat from the at least one battery 11 to a battery external environment. Alternatively, the control system 16 can be located outside of the heat-transfer system 10 within the vehicle 1. The data processing apparatus 21, the computer program product 19 can be located near or within the battery 2 as shown in this example or outside of the battery 2 within the vehicle 1. The sensor 17 can be arranged within or at the battery 2 or within or at the at least one battery unit 11. The computer program product 19 can be running on a data processing apparatus 21 of the vehicle 1 which can be a central or board computer for example, carrying out other tasks in addition to the method 100. Consequently, the heat-transfer can be carried out by the heat-transfer system 10 by transferring heat from the at least one battery unit 11 with the first heat-conducting element 12 via the second heat-conducting element 13.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities can optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) can refer, in one example, to at least one, optionally including more than one, A, with no B present (and optionally including entities other than B); in another example, to at least one, optionally including more than one, B, with no A present (and optionally including entities other than A); in yet another example, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” can mean A alone, B alone, C alone, A and B together, A and C together, B and C together, A, B, and C together, and optionally any of the above in combination with at least one other entity.

Other variations to the disclosed examples can be understood and effected by those skilled in the art in practicing the claimed disclosure, from the study of the drawings, the disclosure, and the appended claims. In the claims the word “comprising” does not exclude other elements or steps and the indefinite article “a” or “an” does not exclude a plurality. A single processor or other unit can fulfill the functions of several items or steps recited in the claims. The mere fact that certain measures are recited in mutually different dependent claims does not indicate that a combination of these measures cannot be used to advantage. A computer program can be stored/distributed on a suitable medium such as an optical storage medium or a solid-state medium supplied together with or as part of other hardware, but can also be distributed in other forms, such as via the Internet or other wired or wireless telecommunication systems. Any reference signs in the claims should not be construed as limiting the scope of the claims.

### LIST OF REFERENCE SIGNS

1 vehicle
2 battery
10 heat-transfer system
11 battery unit
12 first heat-conducting element
13 second heat-conducting element
14 spacer
15 cooling plate
16 control system
17 sensor
18 actuator
19 computer program product
20 pre-existing cooling system
21 data processing apparatus
100 method
S102-S107 steps of the method

What is claimed is:

1. A heat-transfer system for a battery having at least one battery unit, the heat-transfer system comprising:
a first heat-conducting element for thermal connection to the at least one battery unit;
a second heat-conducting element for thermal connection to a battery external environment; and
an actuator configured to alter a position of the first heat-conducting element between a first position for connecting the first heat-conducting element to at least one of the second heat-conducting element and the at least one battery unit and a second position for disconnecting the first heat-conducting element from at least one of the second heat-conducting element and the at least one battery unit,
wherein the first heat-conducting element is configured to receive heat from the at least one battery unit and transfer the heat to the second heat-conducting element in the first position.

2. The heat-transfer system of claim 1, wherein the first heat-conducting element comprises a first portion for connection to the at least one battery unit in the first position and a second portion for connection to the second heat-conducting element in the first position, and wherein the second portion is arranged at an end of the first portion.

3. The heat-transfer system of claim 2, wherein the second portion of the first heat-conducting element extends transverse to the first portion of the first heat-conducting element.

4. The heat-transfer system of claim 2, further comprising:
a control system for receiving a signal indicative of a temperature of the at least one battery unit, wherein the control system is configured to control the actuator to alter the position of at least the first portion or the second portion of the first heat-conducting element based on the signal.

5. The heat-transfer system of claim 4, wherein the control system is configured to control the actuator to alter the position of at least the first portion or the second portion of the first heat-conducting element based on a comparison of the signal to a threshold.

6. The heat-transfer system of claim 4, wherein the control system is configured to control the actuator to alter the position of at least the first portion or the second portion of the first heat-conducting element based on the signal indicative of the temperature of the at least one battery unit and at least one further signal indicative of the temperature of a vehicle comprising the heat-transfer system or a temperature of a surrounding of the at least one battery unit.

7. The heat-transfer system of claim 2, wherein the actuator is configured to alter the position of at least the first portion or the second portion of the first heat-conducting element by at least one of a linear movement or a rotating movement of at least the first portion or the second portion of the first heat-conducting element.

8. The heat-transfer system of claim 1, further comprising:
a spacer that spaces apart the second heat-conducting element from the at least one battery unit.

9. The heat-transfer system of claim 8, wherein the spacer comprises a lower thermal conductivity than the second heat-conducting element.

10. The heat-transfer system of claim 1, further comprising:
a cooling plate for thermal connection to the at least one battery unit and a heat sink.

11. The heat-transfer system of claim 10, further comprising:
a cooling circuit that connects the cooling plate to the heat sink.

12. The heat-transfer system of claim 1, wherein the second heat-conducting element is at least a portion of a battery housing for the at least one battery unit.

13. A battery, comprising:
at least one battery unit; and
a heat-transfer system, comprising:
a first heat-conducting element for thermal connection to the at least one battery unit,
a second heat-conducting element for thermal connection to a battery external environment, and
an actuator configured to alter a position of the first heat-conducting element between a first position for connecting the first heat-conducting element to at least one of the second heat-conducting element and the at least one battery unit and a second position for disconnecting the first heat-conducting element from at least one of the second heat-conducting element and the at least one battery unit,
wherein the first heat-conducting element is configured to receive heat from the at least one battery unit and transfer the heat to the second heat-conducting element in the first position.

14. The battery of claim 13, wherein the first heat-conducting element comprises a first portion for connection to the at least one battery unit in the first position and a second portion for connection to the second heat-conducting element in the first position, and wherein the second portion is arranged at an end of the first portion.

15. The battery of claim 14, wherein the second portion of the first heat-conducting element extends transverse to the first portion of the first heat-conducting element.

16. The battery of claim 14, further comprising:
a control system for receiving a signal indicative of a temperature of the at least one battery unit, wherein the control system is configured to control the actuator to alter the position of at least the first portion or the second portion of the first heat-conducting element based on the signal.

17. The battery of claim 16, wherein the control system is configured to control the actuator to alter the position of at least the first portion or the second portion of the first heat-conducting element based on a comparison of the signal to a threshold.

18. The battery of claim 16, wherein the control system is configured to control the actuator to alter the position of at least the first portion or the second portion of the first heat-conducting element based on the signal indicative of the temperature of the at least one battery unit and at least one further signal indicative of the temperature of a vehicle comprising the heat-transfer system or a temperature of a surrounding of the at least one battery unit.

19. The battery of claim 14, wherein the actuator is configured to alter the position of at least the first portion or the second portion of the first heat-conducting element by at least one of a linear movement or a rotating movement of at least the first portion or the second portion of the first heat-conducting element.

20. A method for controlling a heat-transfer in a battery having at least one battery unit, the method comprising:
obtaining, by a device comprising a processor, a signal indicative of a temperature of the at least one battery unit;
comparing, by the device, the signal to a threshold; and
obtaining, by the device, a control signal for an actuator of the at least one battery unit based on the comparison, wherein the control signal is executable by the actuator for altering a position of at least a first portion or a second portion of a first heat-conducting element of the at least one battery unit between a first position for connecting the first heat-conducting element to at least one of a second heat-conducting element of the at least one battery unit and a second position for disconnecting the first heat-conducting element from at least one of the second heat-conducting element and the at least one battery unit.
